(19) United States
(12) Patent Application Publication
(10) Pub. No.: US 2008/0307056 A1
(43) Pub. Date: Dec. 11, 2008

(54) Web Services Reliable Messaging

(76) Inventor: Vladimir Videlov, Sofia (BG)

Correspondence Address: SAP/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/759,483

(22) Filed: Jun. 7, 2007

(51) Int. Cl. G06F 15/16

(52) U.S. Cl. 709/206

(57) ABSTRACT

A method and system to communicate reliably using messages in a communications network is described. Using the described method, a service provider and a service consumer communication using web services messages can track messages using an instance of a reliable messaging protocol to track message receipt. Using a messaging system independent from a web services runtime environment of the service provider or consumer, the system is able to provide additional services such as queuing, scheduling, and delivery quality of service.

### FIELD OF INVENTION

The field of invention relates generally to the software arts, and, more specifically, to message processing systems.

### BACKGROUND

The term “web services” is understood to mean a standards-based, service oriented architecture (SOA) than can be used to engage in business relationships in a partially or wholly automated fashion over a communications network.

In a basic web services model a service provider and a service consumer exchange messages over a communications network. A service consumer is understood to be an entity that seeks and uses a particular web service through a network. A service provider is the provider of one or more web services that can be accessed over the network.

According to a widely adopted approach, with respect to the actual communication that occurs between the service consumer and the service provider, such communication is implemented through an exchange of Simple Object Access Protocol (SOAP) text messages written in eXtensible Markup Language (XML). A SOAP message is viewed as being contained within an envelope that further contains a header and a body. As the SOAP protocol is transport-independent a number of protocols may be used to exchange SOAP messages, such as HTTP, HTTPS, SMTP, POP3, and FTP. For a particular web service, the header is typically used to pass “control” information associated with the consumer's web service engagement with the web service provider (e.g., information used for performing encryption/decryption and/or signature checking, information used to ensure proper ordering of SOAP messages, information that identifies the ultimate destination of the SOAP message, etc.). The body is used to pass business data.

In basic cases where a service provider receives a SOAP message sent by a service consumer, or, where a service consumer receives a SOAP message sent by a service provider, the body of the SOAP message essentially represents the purpose of the communication between the service provider and service consumer. For instance, the body may contain a request to perform a specific method and any input parameters that are both needed by the method and determined by the service requester. A web service's “endpoint” is essentially the portion of the service provider's software that is responsible for comprehending the received message's body and taking appropriate action in response (e.g., performing some act and then generating the body of a “response” message that is to be sent to the sender of the message). Thus, a web service's substantive processes (i.e., those relating to the body of its message) are essentially defined by its endpoint's methods.

The web services architecture also supports “extensions” to the SOAP messaging format that are available if desired, but, are not required to be SOAP compatible. For instance, a “WS-Security” extension has been defined that specifies information to be contained within a SOAP message header if encryption/decryption and/or authentication procedures are to be performed upon a SOAP message; a “WS-Addressing” extension has been defined that specifies information to be contained within a SOAP header that describes the destination of the SOAP message in a transport independent fashion.

Thus, in order to effect a particular web services business relationship, those SOAP extensions deemed appropriate for the relationship are effectively implemented into the procedures of the relationship by enhancing the SOAP message header with the corresponding information of each appropriate extension, and, any other SOAP extensions that are not deemed appropriate may simply be ignored.

To support necessary extensions, the web services architecture uses the so-called protocol stack, wherein each extension is a protocol that performs some desired processing. The protocol stack corresponds to the program code used to: 1) process an object-oriented representation of the received message's header information; and, 2) generate an object-oriented representation of the header information for the response message. Different combinations of protocols are used to implement customized SOAP message control treatment on a per web service basis. For instance, if a first web service requires some kind of security operation but does not require any comprehension/manipulation of a SOAP message header by the web service's endpoint, the protocol stack for the first web service would include the WS-Security protocol but not the Headers protocol.

When applications engage into communication, this communication may fail due to a number of reasons. For example, a communications network may experience downtime, servers may crash, or there may be power outage. The problems that occur in the process of communication between two or more applications exist when applications use messages to communicate as well. To ensure that communication between applications proceeds smoothly and completely, it is desired that a way to ensure message delivery is implemented.

A generic way to track and ensure message delivery in prior art frameworks is for communicating entities to confirm receipt of data. For example, a source application initiates communication and transmits data over a communications network to a destination application. Upon receipt of the sent data, the destination application will in turn initiate communication with the source application. The destination application sends a receipt for the received data, that is, acknowledges the receipt of data. With such a confirmation receipt the source application deems the communication successful and completes the communication cycle.

### SUMMARY

A method and system to reliably exchange messages over a communications network is described. Using the described method, entities engage in communication using messages such as web services messages and track message receipt using an instance of a reliable messaging protocol. Further, entities use a messaging system independent from a web services runtime environment to be able to achieve additional delivery assurance options.

### BRIEF DESCRIPTION OF THE DRAWINGS

A better understanding of the present invention can be obtained from the following detailed description in conjunction with the following drawings, in which:

FIG. 1 is a flowchart that illustrates the steps the web services reliable messaging protocol performs to process a message;

FIG. 2 is a flowchart that illustrates the steps the Messaging System of FIG. 3 in the web services runtime environment; performs to process a message;

FIG. 3 is a block diagram of the Messaging System and the services it provides to the web services runtime environment;

FIG. 4 is a flowchart that illustrates message processing on the web services server side;

FIG. 5 shows the entities that process messages on the web services client side;

FIG. 6 shows a method for processing inbound messages on the web Services Server side designed to be executed by the entities of FIG. 4;

FIG. 7 shows an improved web services message processing framework with the process flow for processing each type of message call on both the web services client and web services server side.

FIG. 8 depicts a method for outbound processing on the web services client side designed to be executed by the entities of FIG. 5;

FIG. 9 depicts a method for inbound processing on the web services client side designed to executed by the entities of FIG. 5;

FIG. 10 depicts a method for outbound processing on the web services server side designed to be executed by the entities of FIG. 6;

FIG. 11 is a block diagram of an exemplary messages exchange in a message sequence by a web Services Client and a web Services Server.

### DETAILED DESCRIPTION

A message processing system (hereinafter referred to as “web services framework”, “WSF”, or “web services runtime environment”) extends the protocol stack used to process messages with a web services Reliable Messaging (hereinafter referred to as “WS-RM”) protocol. The WS-RM, together with an independent Messaging System (hereinafter referred to as “MS”) provides additional functionality to the WSF. With this enhancement of the WSF and the message handling process, the improved WSF is able to provide a number of benefits, such as ensuring message delivery, providing delivery assurance options, tracking messages, ordering messages, and so on.

The prior art WSF processes messages in the same way, regardless of the location of the processing. This means that the prior art WSF does not distinguish between messages processed on the web services consumer (hereinafter referred to as “Client”) side and messages processed on the web services provider (hereinafter referred to as “Server”) side. In one embodiment of the invention, an improved WSF processes messages differently on the Client and on the Server side. Thus, the WSF on the Client and Server sides is able to differentiate between the specific requirements of message processing depending on the location where the processing takes place.

When an embodiment of the invention processes SOAP messages, it invokes WS-RM on each SOAP request, response, and fault message. The respective interfaces provide methods for handling each message type. To process messages, the WSF creates a configuration context object that includes the SOAP message. This is needed because the WSF does not directly process SOAP messages in the XML format they are received in. The WSF processes object-oriented representations of SOAP messages and also passes administrative information in an object-oriented representation. The administrative information may include instructions for protocols to perform a task, acknowledgements for events, and so on. In this sense, the configuration context is a placeholder for administrative and business data and is the entity that the WSF processes using the protocol stack. Thus, both on the Client and Server sides, each message processing sequence starts with creating a configuration context object, serializing business data (data from applications or data received in the form of a SOAP message), and including the business data in the configuration context object. Moreover, both on the Client and Server sides, the entities that participate in message processing manipulate the configuration context object as necessary to perform the requested communication.

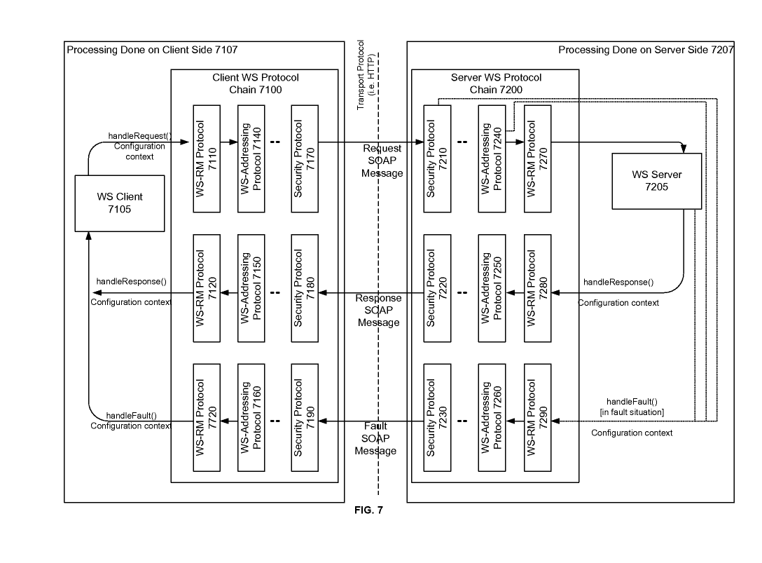

FIG. 7 depicts a high level process flow for SOAP messages communication between a Client and a Server entity for each message type. On the Client side 7107, the WS Client WSF 7105 builds a configuration context object to store information about needed processing and protocol invocation. Based on the instructions written in the configuration context object (i.e. the administrative information), the WSF 7105 reads the configuration context, estimates what processing will be needed, and builds a protocol chain accordingly. The WSF 7105 invokes each protocol needed to process the message by calling each protocol's handleRequest( )method. For example, the WS Client 7105 invokes handleRequest( ) on the WS-Addressing Protocol 7140, and when the WS-Addressing protocol completes processing, the WS Client 7105 invokes handleRequest( ) on the next protocol in the chain, for instance the WS-Security Protocol 7110. Then other protocols are invoked and finally after all necessary processing has been done, a SOAP request message is constructed from the configuration context object and sent over a communications network via a transport protocol such as the Hyper Text Transfer Protocol (hereinafter referred to as “HTTP”). On the Server side 7207, the SOAP message is received over the communications network and the Server WSF 7205 reads the configuration from the received message and builds a configuration context object. Based on the configuration context object, the Server WSF 7205 invokes protocols in the reverse order to process the received message. After the message is processed, the WSF on the Server side 7205 constructs a response and invokes handleResponse( ) on each protocol needed to process the response message and send it back over the communications network to the requesting entity 7105. At some point, it is conceivable that the communication may break down and if the Server 7205 is unable to construct a response, it constructs a fault message to notify the requesting entity 7105 of the occurred event. Thus the WSF on the Server side 7205 invokes handleFault( ) on each protocol in the chain and the SOAP message is sent over the communications network. Note that because of the differentiated processing on the Client and Server sides, a different protocol chain is constructed depending on the location of the processing and on the type of the SOAP message that is being processed. The present embodiment is described in connection with an exchange of SOAP messages using HTTP. In an alternative embodiment, other protocols may be used to exchange SOAP messages. Such protocols include, but are not limited to HTTPS, SMTP, POP3, and FTP.

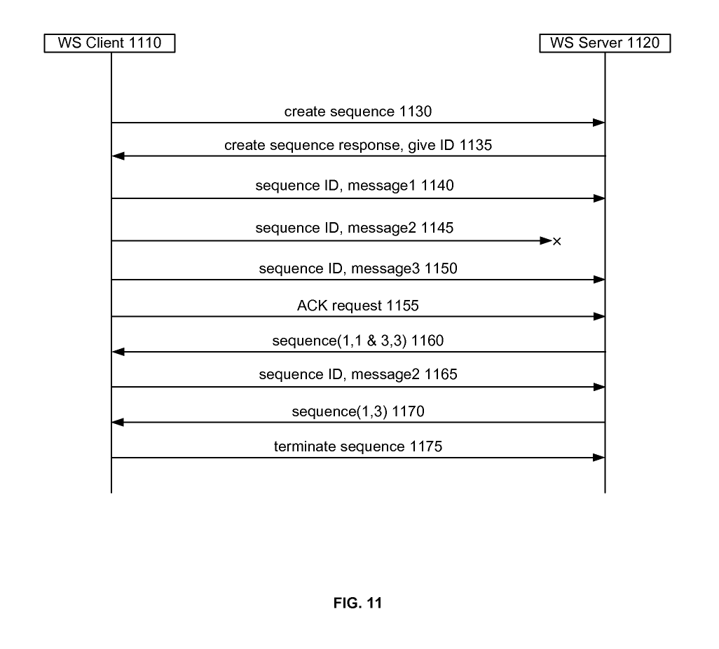

As noted above, improvements over the prior art WSF are achieved with the extension of the protocol stack to include a WS-RM Protocol. Referring to FIG. 7, distinguishing between the different processing requirements on the Client side 7107 and the Server side 7207 and distinguishing between different SOAP message types, the respective WSFs invoke the WS-RM at different times. For example, the WS Client 7105 builds a SOAP request message by building a protocol chain starting with an invocation of the WS-RM 7110, while the WS Server 7205 processes the received SOAP message by building a protocol chain that completes with the WS-RM 7270. Using the WS-RM, the WSF is able to track message delivery. For example, as shown on FIG. 11, in a basic reliable message exchange scenario, a WS Client 1110 sends a create sequence request 1130 to a WS Server 1120. The WS Server 1120 accepts the request, creates a sequence response and provides an ID for the expected sequence 1135. With the established message sequence, the WS Client 1110 starts sending messages, 1140, 1145, and 1150, respectively. In order to track message delivery, the WS Client 1110 sends a request for an acknowledgement of the message receipt 1155. As shown on the figure, the delivery of message 2 1145 fails. Thus, the WS Server 1120 acknowledges the receipt of messages 1 and 3 only, with the sequence response 1160. Upon notification of the failed message the WS Client 1110 resends message 2 1165. Thus, the WS Server 1120 confirms receipt of all messages in the sequence 1170 and the WS Client 1110 terminates the sequence 1175 as all intended messages have been successfully sent.

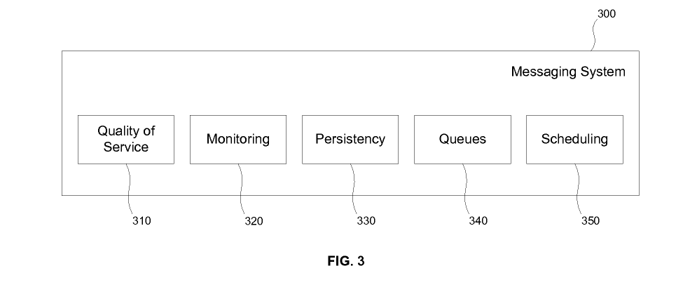

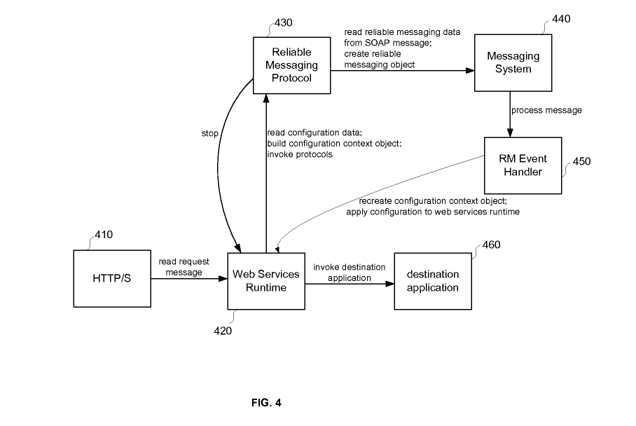

However, business scenarios may need additional options beside a simple notification of success or failure of communication. Using the MS, the WS-RM extends processing with additional services and is able to request specific options for message delivery and track how messages are delivered to their intended destinations. Referring to FIG. 3, the MS 300 provides services such as Quality of Service 310, Monitoring 320, Persistency 330, Queuing 340, and Scheduling 350. This document focuses on the processing done by the WS-RM and the further processing done in the MS so that messages are delivered reliably, and in a specified manner.

FIG. 1 depicts processing done by the WS-RM. When the WS-RM is invoked by the WSF, it reads the configuration context and adds sequencing data 110 to the configuration context object. As noted above, the sequencing data is used to confirm delivery receipt or failure. With respect to the delivery assurance options noted in the previous paragraph, the WS-RM estimates which delivery assurance options are needed in the particular communication and sets them forth as instructions for the MS to perform. Thus, the WS-RM then writes instructions for the MS 120 and serializes the configuration context 130. It includes the serialized configuration context in a Reliable Messaging (RM) message object and sends this RM object to the MS 140. After the RM object is sent, the WS-RM stops the WSF 150 and the MS starts further processing as requested in the received instructions.

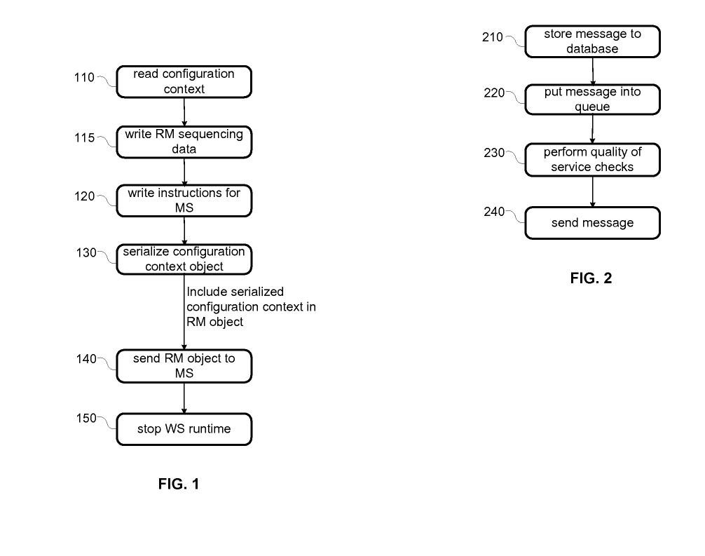

Referring to FIG. 2, when the MS receives the RM object, it stores it to a database 210. After storing a persistent state of the RM object to the database, the MS places all message objects that are ready to be sent out in a queue 220. Before message objects can be sent on to the next protocol in the chain for processing, the MS also performs Quality of Service (QoS) checks 230. Via the QoS checks the MS provides delivery assurance options and ensures the correct scheduling according to the configured delivery policy. If the message object satisfies the required delivery policy option, the configuration context is recreated and the configuration is applied to the WSF and the WSF is restarted to continue processing with the next protocol in the chain.

With the processing performed by the WS-RM and the MS, an improved WSF is able to serve a number of business scenarios. For example, in a complex communication between two applications over a communications network, in the event of system downtime, the MS is able to recreate the state of the communication from the stored persistent state and correctly schedule remaining parts of the communication. Also, in a complex scenario, as numerous messages are exchanged, it may be required that messages are monitored for performance benchmarking and optimization. Further still, communication over a network may involve a plurality of stakeholders and entities exchanging messages and in such cases the MS can analyze the required order of messages and queue them accordingly.

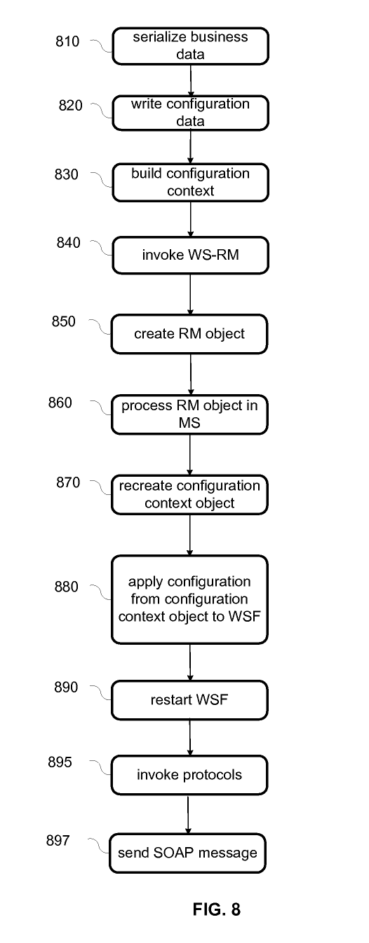

As the processing of a SOAP message in a WSF is different on the Client and Server sides, the following paragraphs outline the specifics of processing on both sides. Referring to FIG. 5 and FIG. 8, communication is initiated via outbound messages on the Client side. The application 510 sends the message to the WSF 520. The WSF 520 reads the message and serializes the business data 810 and its configuration information 820 and builds the protocol chain needed to process the message. The WSF 520 builds the configuration context 830, invokes the WS-RM 840, and sends the configuration context to the WS-RM 530. The WS-RM 530 creates a RM object 850, serializes the configuration context, includes it in the RM object and stops the WSF 520. The WS-RM 530 sends the RM object to the MS 540. The MS 540 processes the message object 860 and sends it to the RM Event Handler 550. The RM Event Handler 550 recreates the configuration context 870, applies the configuration from the configuration context 880 to the WSF 520 and restarts the WSF 520, 890. The WSF 520 then invokes other protocols 895. Finally, when the processing is completed a SOAP message is created and sent 897 over a communications network using a transport protocol such as HTTP or HTTPS 550 to the destination.

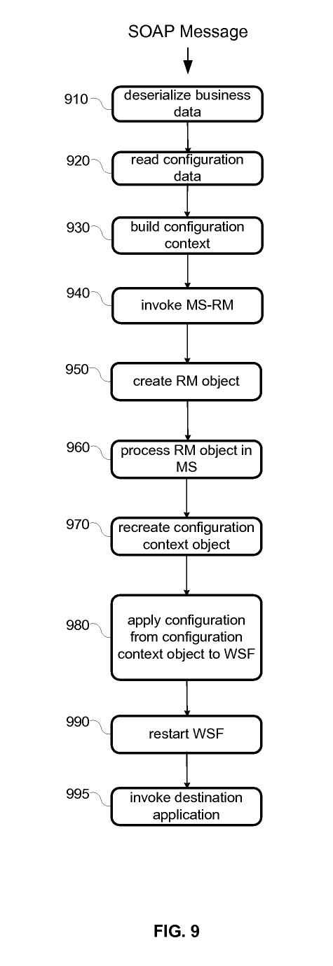

In the embodiment of the invention discussed above, the Client communicates with the Server via outbound messages only, using handleRequest( ) method calls. However, it is conceivable that in other embodiments of the invention the Client may handle more than one WS-RM sequence for SOAP requests simultaneously. In contrast to the outbound processing discussed above, here the Client processes the message invoking instances of the protocols in reverse order using handleResponse( ) method calls. After all needed protocols have processed the message, the Client deserializes the SOAP message and builds a result for the application that the message is directed to, as shown in FIG. 9.

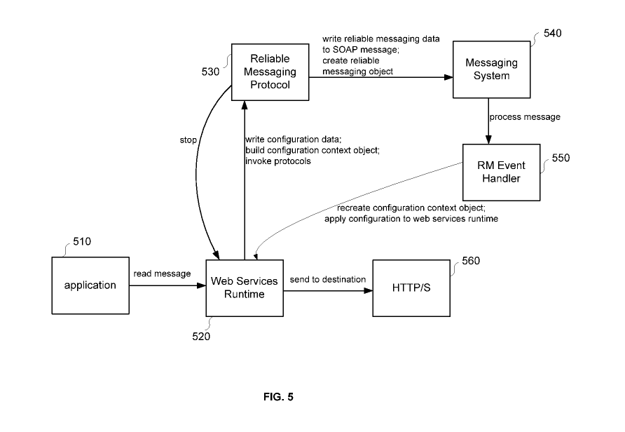

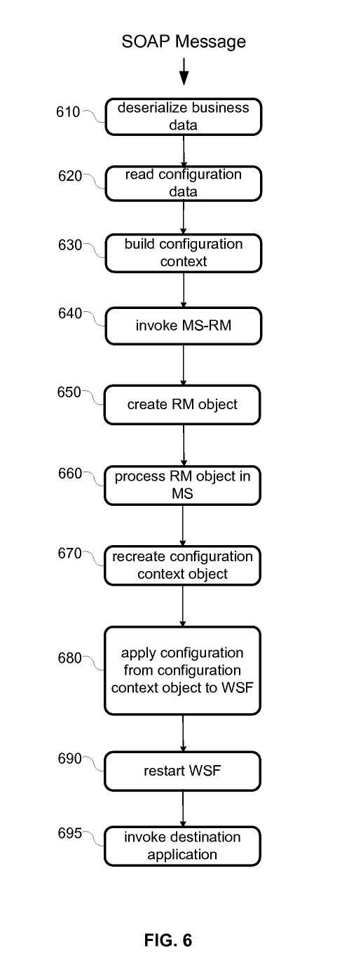

Referring to FIG. 4 and FIG. 6, when an inbound SOAP message is received at the Server side, the WSF 420 reads the received message from the transport protocol 410. The WSF 420 reads 610 the message and its configuration information 620 and builds a configuration context 630. The WSF 420 then serializes SOAP message, includes it in the configuration context and invokes the WS-RM 430, 640. The WS-RM 430 serializes the configuration context, builds a RM message object 650, includes the serialized configuration context in the RM object and stops the WSF 420. The WS-RM 430 sends the RM object to the MS 440. The MS 440 processes the message object 660 and sends it to the RM Event Handler 450. The RM Event Handler 450 recreates the configuration context 670, applies the configuration 680 from the configuration context to the WSF 420 and restarts 690 the WSF 420. The WSF 420 then invokes the destination application 695 and sends the SOAP message to it.

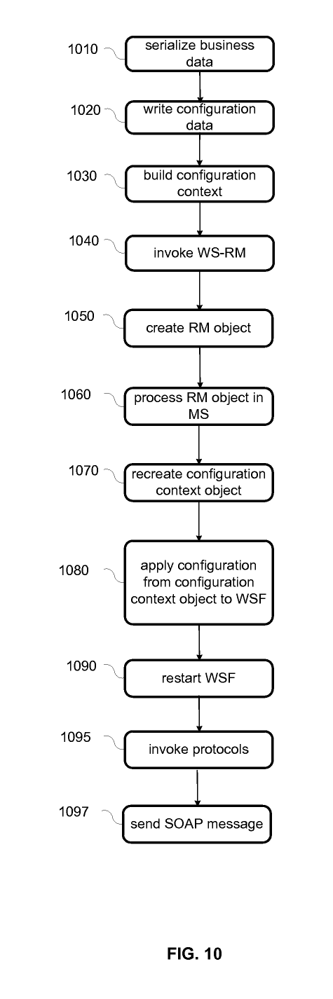

After the destination application performs the functions it was requested to do in the request SOAP message, it sends a response. Thus, as shown in FIG. 10, the Server reads the business data received from the application, serializes the data 1010 and builds a configuration context 1030 to use for building the response. The Server starts calling the handleResponse( ) methods on all protocols in the chain to build the response SOAP message. Depending on the desired configuration, the WS-RM may invoke the MS synchronously or asynchronously. After all protocols have processed the configuration context as required by the configuration in the message received from the application, the Server builds a SOAP message and sends it to the source application that initiated the communication over a communications network. If the Server encounters an error in building the response message, the processing stops and the Server continues with calling the handleFault( ) methods of each protocols in order to build a fault message to send to notify the requesting Client of the error.

Elements of embodiments of the invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cares, propagation media or other type of machine-readable media suitable for storing electronic instructions. For example, embodiments of the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

In the foregoing specification, the invention has been described with reference to the specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
creating a reliable messaging object comprising a configuration context object;
receiving the reliable messaging object in a messaging system (MS) independent from a web services runtime environment; and
processing the reliable messaging object in the MS.

2. The method of claim 1, wherein the configuration context object comprises a serialized web services message object and configuration data.

3. The method of claim 1, wherein creating the reliable messaging object comprises:
reading configuration data from the configuration context object;
writing instructions for delivery of the reliable messaging object based on the configuration data from the configuration context object; and
stopping the web services runtime environment at an endpoint after creating the reliable messaging object.

4. The method of claim 3, further comprising writing sequencing data to the reliable messaging object, wherein the sequencing data in the reliable messaging object tracks sequences of messages exchanged between endpoints over a communications network.

5. The method of claim 1, wherein processing the reliable messaging object in the MS comprises:
storing a state of the web services runtime environment in a database;
storing the received reliable messaging object in a database;
placing the reliable messaging object into a queue;
performing a quality of service check on the reliable messaging object; and
invoking an instance of an event handler to restart the web services runtime environment after the quality of service check has been performed on the reliable messaging object.

6. The method of claim 5, wherein performing the quality of service check on the reliable messaging object comprises:
determining a delivery policy for the reliable messaging object from instructions for delivery written to the reliable messaging object;
checking if the reliable messaging object satisfies the delivery policy;
sending a part of the reliable messaging object that satisfies the delivery policy to an event handler object; and
retaining a part of the reliable messaging object that does not satisfy the delivery policy.

7. The method of claim 5, wherein invoking an instance of an event handler to restart the web services runtime environment comprises:
recreating the configuration context object;
applying a configuration from the configuration context object to the web services runtime environment; and
restarting the web services runtime environment after applying the configuration from the configuration context object.

8. A system comprising:
a software application coupled to an endpoint on a communications network to send or receive business data over the communications network;
a web services runtime environment coupled to the endpoint to invoke an instance of a reliable messaging protocol to process a web services message object in a predefined way;
an instance of a reliable messaging protocol to create a reliable messaging object comprising the web services message object and invoke an instance of a messaging system (MS) independent from the web services runtime environment at the endpoint on the communications network;
a messaging system independent from the web services runtime environment coupled to the endpoint on a communications network to provide services for processing the reliable messaging object;
an instance of an event handler coupled to the messaging system to invoke calls to the web services runtime environment after the messaging system has processed the reliable messaging object; and
an instance of a Hyper Text Transfer Protocol (HTTP) coupled to the endpoint to enable sending and receiving a web services message over a communications network.

9. The system of claim 8, wherein the messaging system independent from the web services runtime environment comprises:
a service to monitor the delivery of a reliable messaging object created by an instance of a reliable messaging protocol;
a service to store the reliable messaging object to a database coupled to a web services runtime environment on an endpoint on a communications network;
a service to queue the reliable messaging object;
a service to perform quality of service checks on the reliable messaging object; and
a service to send or retain parts of the reliable messaging object according to a delivery policy specified by the instance of the reliable messaging protocol.

10. A machine readable medium having instructions therein that when executed by the machine cause the machine to:
create a reliable messaging object comprising a configuration context object;
receive the reliable messaging object in a messaging system (MS) independent from a web services runtime environment; and
process the reliable messaging object in the MS.

11. The machine readable medium of claim 10, wherein the instructions that cause the machine to create the reliable messaging object, cause the machine to:
read configuration data from the configuration context object;
write instructions for delivery of the reliable messaging object based on the configuration data from the configuration context object; and
stop the web services runtime environment at an endpoint after creating the reliable messaging object.

12. The machine readable medium of claim 11, wherein the instructions that cause the machine to create the reliable messaging object, further cause the machine to write sequencing data to the reliable messaging object, wherein the sequencing data in the reliable messaging object tracks sequences of messages exchanged between endpoints over a communications network.

13. The machine readable medium of claim 10, wherein the instructions that cause the machine to process the reliable messaging object in the MS, cause the machine to:
store a state of the web services runtime environment in a database;
store the received reliable messaging object in a database;
place the reliable messaging object into a queue;
perform a quality of service check on the reliable messaging object; and
invoke an instance of an event handler to restart the web services runtime environment after the quality of service check has been performed on the reliable messaging object.

14. The machine readable medium of claim 13, wherein the instructions that cause the machine to perform a quality of service check, cause the machine to:
determine a delivery policy for the reliable messaging object from instructions for delivery written to the reliable messaging object;
check if the reliable messaging object satisfies the delivery policy;
send a part of the reliable messaging object that satisfies the delivery policy to an event handler object; and
retain a part of the reliable messaging object that does not satisfy the delivery policy.

15. The machine readable medium of claim 13, wherein the instructions that cause the machine to invoke an instance of an event handler, cause the machine to:
recreate the configuration context object;
apply a configuration from the configuration context object to the web services runtime environment; and
restart the web services runtime environment after applying the configuration from the configuration context object.
